(19) United States
(12) Patent Application Publication
(10) Pub. No.: US 2011/0309159 A1
(43) Pub. Date: Dec. 22, 2011

(54) WATER TOY DEVICE

(76) Inventor: Jerard Maurice Goldsmith, Broomfield, CO (US)

(21) Appl. No.: 13/011,682

(22) Filed: Jan. 21, 2011

Related U.S. Application Data
(60) Provisional application No. 61/355,311, filed on Jun. 16, 2010.

(51) Int. Cl. B05B 1/00

(52) U.S. Cl. 239/211

(57) ABSTRACT

A water toy device that is activated by exerting pressure on the device provides a fresh, cool, and clean water supply when required by the pets or children. The water toy device includes an upper shell, a base shell connected to the upper shell, a hollow interior space located between the base shell and the upper shell, at least one spring placed on the hollow interior space, a channel adapted to receive a pressure activated trigger, and an opening located on the upper shell to release the water when the pressure activated trigger is activated.

### CROSS-REFERENCE TO RELATED APPLICATIONS

This application claims the benefit of Provisional Application No. 61/355,311 filed Jun. 16, 2010, the contents of which are incorporated herein by reference.

### BACKGROUND OF THE INVENTION

The present invention generally relates to a water toy device. More specifically, the present invention relates to a water toy device that is activated by the pressure exerted upon the water toy device.

Pets and children love to play with water. Water toys are known in the art to provide pets and children with a drinking water source and/or cooling means during the hot summertime. Unfortunately, the water provided by the known water toy devices has too much exposition to the ambient air promoting the evaporation, contamination, and stagnation of the water, and leaving the pets or children without a fresh and clean water supply.

As can be seen, there is a need to provide a water toy device that offers a fresh, cool, and clean supply of water when required by pets or children.

### SUMMARY OF THE INVENTION

In one aspect of the present invention, a water toy device including an upper shell, a base shell connected to the upper shell, a hollow interior space located between the base shell and the upper shell, at least one spring placed on the hollow interior space, a channel located on the base shell and adapted to receive a pressure activated trigger, and an opening located on the upper shell to release the water when the pressure activated trigger is activated.

In another aspect of the present invention, a water toy device includes an upper shell, a base shell connected to the upper shell, a hollow interior space located between the base shell and the upper shell, at least one spring placed on the hollow interior space, a pressure activated trigger cradled on a channel located on the upper shell, and an opening located on the upper shell to release the water when the pressure activated trigger is activated.

These and other features, aspects and advantages of the present invention will become better understood with reference to the following drawings, description and claims.

### BRIEF DESCRIPTION OF THE DRAWINGS

FIG. 1 illustrates a perspective front view of a water toy device according to an exemplary embodiment of the present invention;

FIG. 2 illustrates a top view of the water toy device of FIG. 1;

FIG. 3 illustrates a cross-sectional view of the water toy device taken along lines 3-3 in FIG. 2;

FIG. 4 illustrates a cross-sectional view of the water toy device taken along lines 4-4 in FIG. 2;

FIG. 5 illustrates a detailed view of the water toy device of FIG. 4 showing the water toy device in a working position;

FIG. 6 illustrates an exploded perspective view of the water toy device of FIG. 1;

FIG. 7 illustrates a detailed section view of the water toy device according to another exemplary embodiment of the present invention; and

FIG. 8 illustrates a detailed view of the water toy device of FIG. 7 showing the water toy device in a working position.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provides a water toy device that is activated by exerting pressure on the device to provide a fresh, cool, and clean water supply when required by the pets or children.

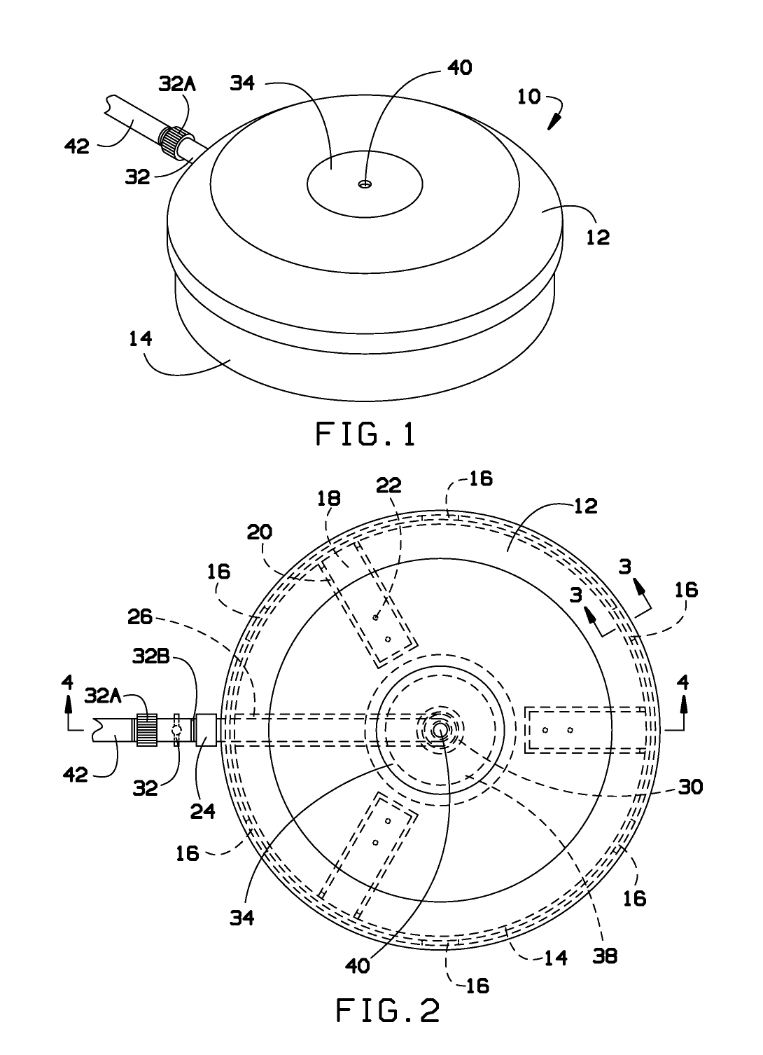

FIG. 1 illustrates a water toy device 10 that may include an upper shell 12 and a base shell 14 connected to the upper shell 12. The upper shell 12 and the base shell 14 may have complementary shapes. The upper shell 12 and base shell 14 may be made of a non-toxic sturdy material. In one embodiment, the upper shell 12 and the base shell 14 may be made of a hard plastic, poly-carbon, a high density polyethylene (HDPE), or a polymer. The size of the upper shell 12 and the base shell 14 may depend on the customer requirements. In one embodiment, the upper shell 12 and the base shell 14 may have a diameter from about 10 inches to about 14 inches. In some embodiments of the present invention, the shape of the upper shell 12 and the base shell 14 may be a triangle, a square, a cylinder, an oval, a circle, a pentagon, a start, a hexagon, a figurine, a flower, or a holiday motive.

The upper shell 12 may include an opening 40 for releasing the water. The opening 40 may include a cover 34 to control the direction of the flow of water exiting the water toy device 10. The cover 34 may include at least one port. The water toy device 10 may be adapted to be connected to a water hose 42. A flow control device 32 may be connected to the water hose 42 to manually adjust the amount of water entering the water toy device 10.

FIGS. 2, 4, and 5 illustrate that the connection between the upper shell 12 and the base shell 14 that forms a hollow interior space 38. The upper shell 12 and the base shell 14 may be secured to each other by fasteners 16 in order to prevent the two bases from separating. In one embodiment, the fasteners 16 may be latch clips. The number of fasteners 16 may depend on the size of the water toy device 10. A plurality of springs 18 may be placed inside the hollow interior space 28. The number of springs 18 may depend on the size of the water toy device 10. The springs 18 may be made of steel or stainless steel. In one embodiment, the spring 18 may a C-shaped spring. One end of each spring 18 may contact the upper plate 12 and the other end may contact the base shell 14. A plurality of spring bases 20 may be placed on the base shell 14. Each spring base 20 may secure one of the springs 18 to the base shell 14 by passing a fastener (not shown) into an orifice 22. The spring bases 20 may be made of a sturdy material. In one embodiment, the spring bases 20 may be made of plastic or metal.

The base shell 14 may include a channel 26 to introduce a pressure activated trigger 24 inside the hollow interior space 28. In one embodiment, the pressure activated trigger 24 may be an integral part of the water toy device 10. In another embodiment, the water toy device 10 may be adapted to be used with a commercially available pressure activated trigger 24. The flow control device 32 may include a first connection device 32A to connect the flow control device 32 to the hose 42 and a second connection device 32B to connect the flow control device 32 to the pressure activated trigger 24. The first connection device 32A and the second connection device 32B may be a female and male threaded connection device. In one embodiment, the first connection device 32A may be a female threaded connection device and the second connection device 32B may be a male threaded connection device.

The springs 18 may surround the pressure activated trigger 24. The pressure activated trigger 24 may be connected to the flow control device 32. The flow control device may be attached to the hose 42.

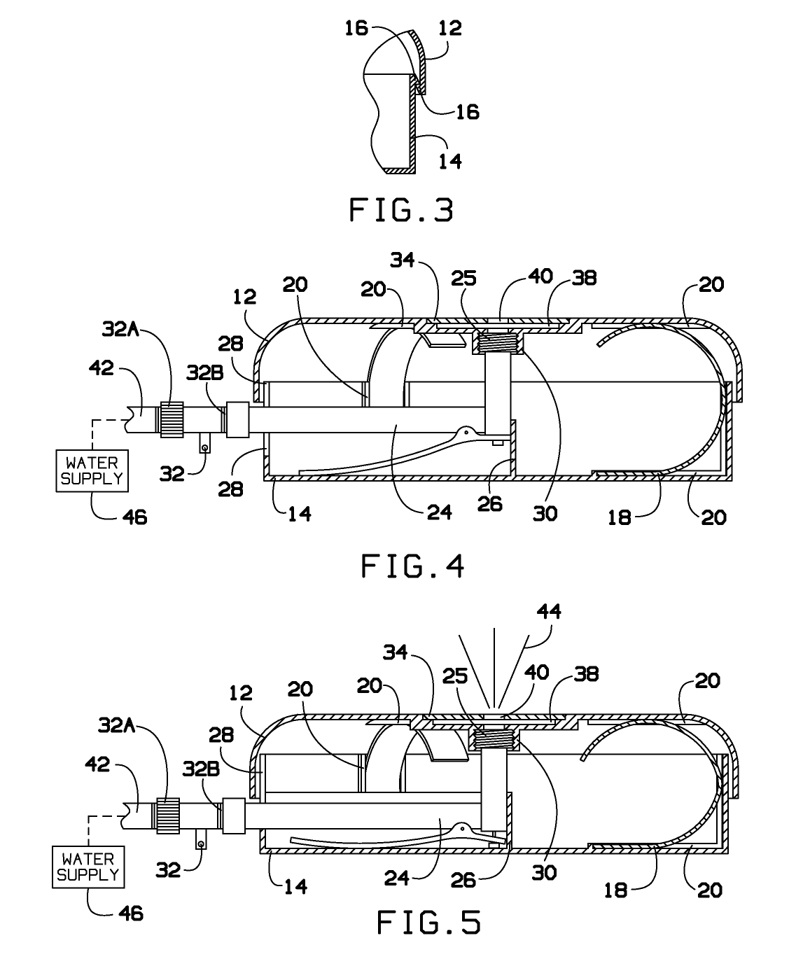

FIG. 3 illustrates a detailed view of how the upper shell 12 and the base shell 14 may be secured by the fastener 16.

FIG. 4 illustrates that the hose 42 may be connected to a water supply 46. The pressure activated trigger 24 may include an outlet end 25 that may be placed on a holder 30 on the upper shell 12. The holder 30 and the outlet end 25 of the pressure activated trigger 24 may have matching interconnecting ends. In one embodiment, the holder 30 and the outlet end 25 of the pressure activated trigger 24 may have matching threaded ends. A water spray 44 may be released from the pressure activated trigger 24 when pressure is exerted on the springs 18.

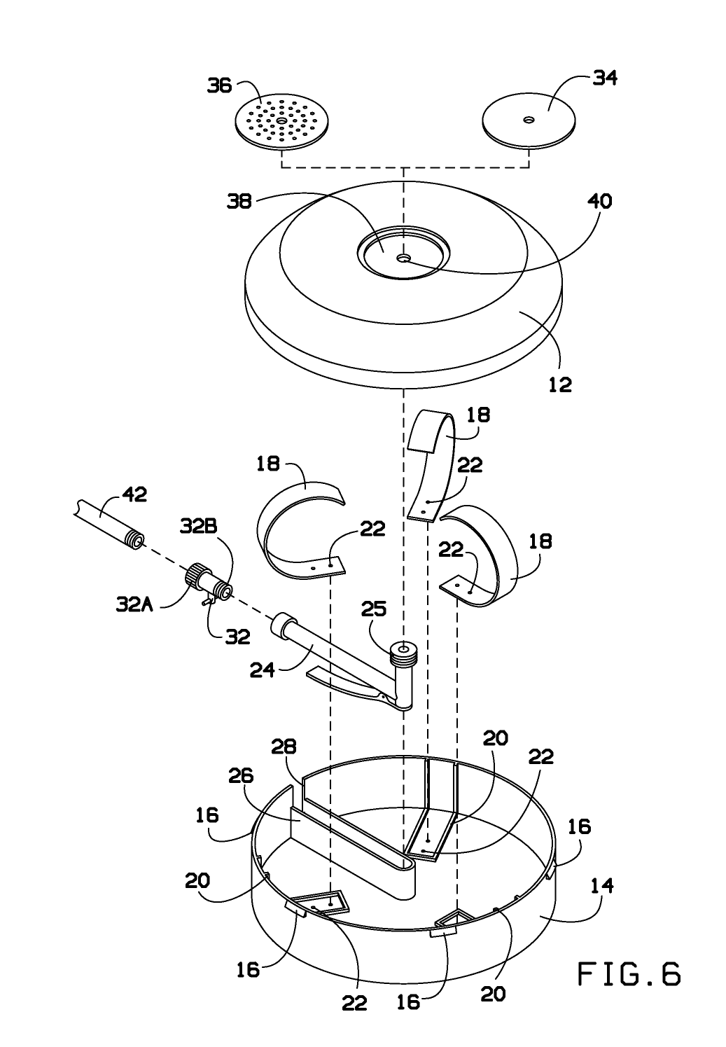

FIG. 6 illustrates an alternative embodiment of the water toy device 10 according to the present invention on which the cover 36 may include multiple ports.

The water discharged may be discharged by pressing down on any part of the upper shell 12; thus, the springs 18 may be compressed between the upper shell 12 and the base shell 14 activating the pressure activated trigger 24, which may release the water into the port of the cover 34 forming the water spray 44. The water discharge may be deactivated by releasing the pressure on the upper shell 12.

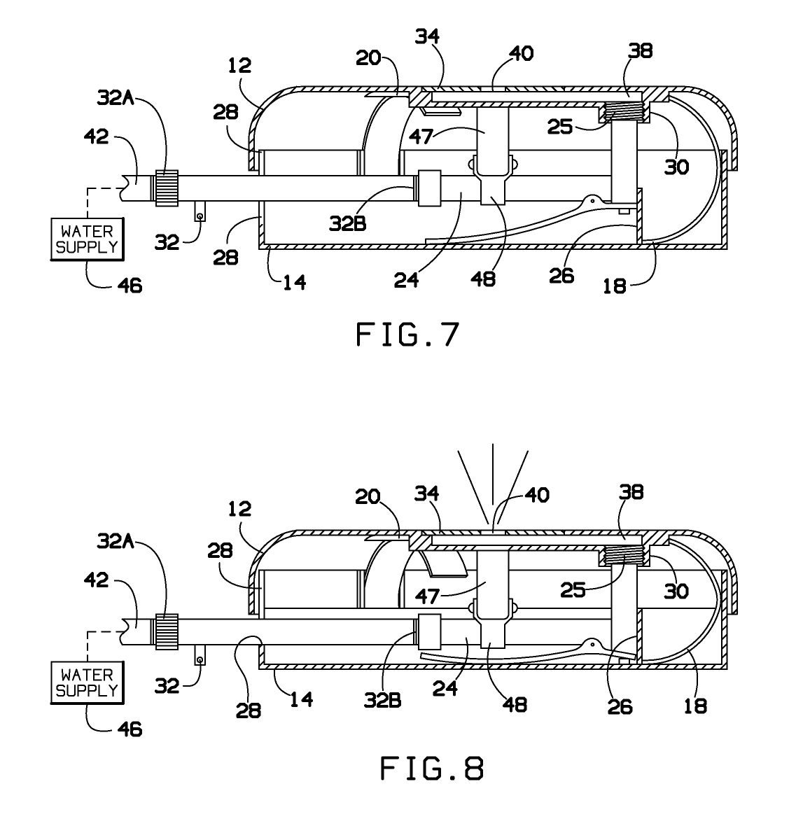

FIGS. 7-8 illustrate a pressure lever support arm 47 attached to the upper shell 12 and a pressure lever clamp 48 connected to the pressure activated trigger 24. The trigger 24 may be attached to the support arm 47 via the pressure lever clamp 48.

In one embodiment, the water toy device 10 may include a water timer and/or an adjustable swivel.

The water toy device 10 may be either free standing to slide across the ground, or secured to a surface.

It should be understood, of course, that the foregoing relates to exemplary embodiments of the invention and that modifications may be made without departing from the spirit and scope of the invention as set forth in the following claims.

We claim:

1. A water toy device comprising:
an upper shell;
a base shell connected to the upper shell;
a hollow interior space located between the base shell and the upper shell;
at least one spring placed on the hollow interior space, wherein each spring has a first end contacting the upper shell and a second end contacting the base shell;
a channel located on the base shell, the channel is adapted to receive a pressure activated trigger; and
an opening located on the upper shell to release the water when the pressure activated trigger is activated.

2. The water toy device according to claim 1, wherein the upper shell and the base shell have complementary shapes.

3. The water toy device according to claim 1, further including a cover connected to the opening, wherein the cover includes at least one slot to release the water.

4. The water toy device according to claim 1, wherein the pressure activated trigger device is connected to a water hose.

5. The water toy device according to claim 4, further including a flow control device connected between the water hose and the pressure activated trigger.

6. The water toy device according to claim 1, further comprising fasteners for securing the upper shell and the base shell to each other.

7. The water toy device according to claim 1, wherein the at least one spring is a C-shaped spring.

8. The water toy device according to claim 1, further including a pressure lever clamp connected to the pressure activated trigger.

9. The water toy device according to claim 1, further including a water timer.

10. A water toy device comprising:
an upper shell;
a base shell connected to the upper shell;
a hollow interior space located between the base shell and the upper shell;
at least one spring placed on the hollow interior space, wherein each spring has a first end contacting the upper shell and a second end contacting the base shell;
a pressure activated trigger attached to pressure lever support arm attached to the upper shell; and
an opening located on the upper shell to release the water when the pressure activated trigger is activated.
